(19) United States
(12) Patent Application Publication
(10) Pub. No.: US 2004/0141720 A1
(43) Pub. Date: Jul. 22, 2004

(54) Combination digital video disk player and video cassette recorder and method for controlling output signal

(76) Inventor: Man-gyu Yim, Yongin-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/755,329

(22) Filed: Jan. 13, 2004

(30) Foreign Application Priority Data
Jan. 16, 2003 (KR) 2003-3135

(51) Int. Cl. H04N 5/76; H04N 5/781

(52) U.S. Cl. 386/46; 386/125

(57) ABSTRACT

A combination system capable of controlling output signals and a method of controlling the same. The combination system includes a first device for generating first analog audio/video signals by reproducing data recorded on a first recording medium, a first signal converting unit for converting the first analog audio/video signals to first digital audio/video signals and outputting the same, and a second device for generating second digital audio/video signals by reproducing data recorded on a second recording medium, and outputting either the first or second audio/video signals through selection, and converting a scanning format of the selected video signal. A user of the combination system is able to enjoy high quality screen images and high quality sound because the A/V signals are supplied to a digital TV after the analog A/V signals output from a VCR of the combination system are converted to digital A/V signals.

### CROSS-REFERENCE TO RELATED APPLICATIONS

This application claims the benefit of Korean Patent Application No. 20033135 filed Jan. 16, 2003, in the Korean Intellectual Property Office, the disclosure of which is incorporated herein by reference.

### BACKGROUND

1. Field of the Invention

The present invention relates video reproduction products, and in particular, to a combination system including a VCR and a DVDP which is capable of controlling output signals, and which supplies A/V signals to a display device after converting analog A/V signals output from the VCR to digital A/V signals.

2. Description of the Related Art

Recording and reproducing devices that are capable of recording A/V (audio/video) signals on a recording medium and reproducing the recorded A/V signals, have been developed to include numerous functions in accordance with the introduction of digital signal processing and compression technologies.

A popular recording and reproducing device currently available is a VCR/DVDP combination system (hereinafter, referred to as the “combo”). The VCR/DVDP combo is a recording and reproducing device performing the complex functions of a video cassette recorder (VCR) as a first device, and a digital video disk reproducer (DVDP) as a second device. In the VCR/DVDP Combo, both the VCR and the DVDP are housed in a single case.

FIG. 1 is a schematic diagram illustrating a conventional VCR/DVDP combo and two peripheral devices connected to the VCR/DVDP combo.

Referring to FIG. 1, the conventional VCR/DVDP combo 10 comprises a VCR 11 for recording A/V signals on a magnetic tape of a cassette and reproducing the recorded A/V signals, and a DVDP 12 for reproducing the A/V signals recorded on a DVD.

The VCR 11 and the DVDP 12 are formed as a single product, i.e., a VCR/DVDP combo 10, and a user can select switching on/off of a reproducing mode between the VCR 11 and the DVDP 12. Further, individual functions of the VCR 11 and the DVDP 12 can be selected by the user by manipulating a remote controller (not shown), or a manipulating panel (not shown) provided on a front surface of the VCR/DVDP combo 10.

The VCR/DVDP combo 10 is connected to a digital TV 20, which is a peripheral device for receiving A/V signals reproduced in the VCR 11 or the DVDP 12, and an audio amplifier 30, which is a peripheral device for receiving audio signals reproduced in the DVDP 12.

Here, the A/V signals supplied from the VCR 11 of the VCR/DVDP combo 10 to the digital TV 20 are analog composite video/audio signals, while the A/V signals supplied from the DVDP 12 to the digital TV 20 can be either analog or digital signals. The signals supplied to the audio amplifier 30 are digital audio signals. The DVDP 12 supplies analog composite video/audio signals or digital RGB video/composite video/audio signals.

If the conventional VCR/DVDP combo 10 is connected to an analog TV (not shown), the VCR 11 supplies analog A/V signals as described above, while the DVDP 12 supplies the A/V signals converted from digital to analog.

By contrast, if the conventional VCR/DVDP combo 10 is connected to a digital TV 20, the DVDP 12 provides it with digital A/V signals including the RGB video signals. However, the VCR 11 is unable to provide the digital TV 20 with digital A/V signals.

Thus, even if the digital TV 20 provides a high quality screen and a high definition image as a peripheral device, the user is unable to take advantage of the high quality screen or the high definition image because the VCR provides only analog A/V signals to the digital TV 20, and the RGB video signals cannot be used when the VCR mode is selected.

### BRIEF DESCRIPTION OF THE DRAWINGS

The above and other objects, features and advantages of the present invention will become more apparent from the following description when taken in conjunction with the accompanying drawings, in which:

FIG. 1 is a schematic diagram illustrating a conventional VCR/DVDP combo and two peripheral devices connected thereto;

FIG. 2 is a schematic diagram illustrating a combination system and two peripheral devices connected thereto according to a preferred embodiment of the present invention;

FIG. 3 is a schematic block diagram illustrating the combination system in FIG. 2; and

FIG. 4 is a flowchart illustrating a method of controlling output signals according to the combination system in FIG. 3.

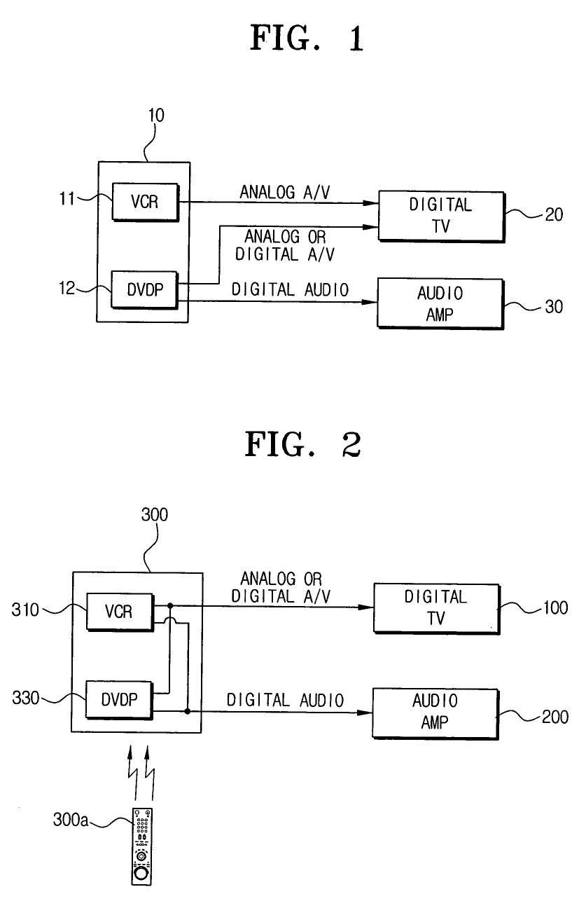

### DESCRIPTION OF THE PREFERRED EMBODIMENT

A preferred embodiment of the present invention will be described below with reference to the accompanying drawings. In the following description, well-known functions or constructions are not described in detail since they would obscure the invention in unnecessary detail.

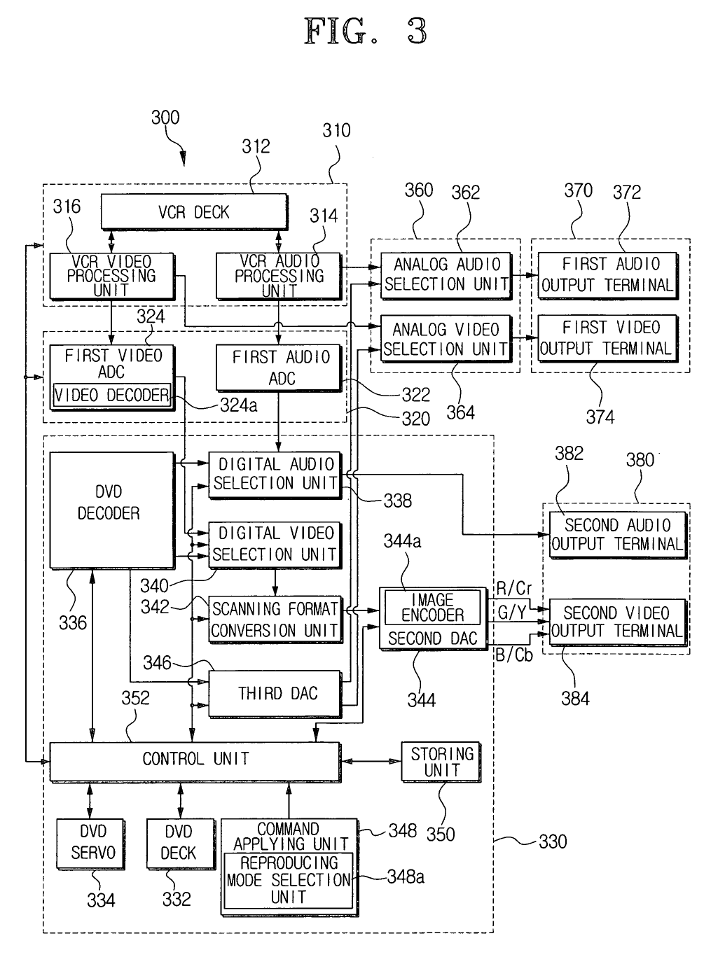

FIG. 2 is a schematic diagram illustrating a combination system and two peripheral devices connected thereto according to a preferred embodiment of the present invention.

Referring to FIG. 2, combination system 300 is a recording and reproducing device integrating a VCR 310 with a DVDP 330 that is connected to a digital TV 100, which is a display device, and an audio amplifier 200, which is a digital sound output device, by means of a transmission cable (not shown).

The combination system (hereinafter, referred to as the ‘VCR/DVDP combo’) 300 processes signals received from a remote controller 300a, which is an external input device, and transmits the displaying information to the digital TV 100. The external input device refers not only to the remote controller 300a, which transmits wireless signals such as an infrared ray, but also to other input devices such as a keyboard.

The VCR 310 is a first device for reproducing recorded data. In this instance, the data is recorded on a magnetic tape (not shown) in a video-cassette, which has been applied as the first recording media. The DVDP 330 is a second device for reproducing recorded data. In the case of the DVD, the data is recorded on an optical recording medium, which has been applied as the second recording media (not shown). Examples of optical recording media include, but are not limited to, DVD, CD (compact disk) and VCD (video compact disk), among others.

The digital TV 100 comprises a digital display device (not shown), such as a conventional TV, and speakers (not shown). Other examples of digital display devices include a PDP (plasma display panel), TV or LCD (liquid crystal display TV. The audio amplifier 200, which is a digital sound amplifying device, outputs a conventional analog audio signal with micro-level noise When the digital A/V signals are input to the digital TV 100 the digital TV 100 provides image and Dolby® system sound with a quality higher than that of an analog TV, such as a CRT (cathode ray tube) TV. A transmission cable connects an input terminal provided in the digital TV 100 to an output terminal (not shown) provided in the VCR/DVDP combo 300 and the audio amplifier 200.

The A/V signals supplied for the digital TV 100 from the VCR/DVDP combo 300 will now be described in greater detail.

The video signal component of the A/V signal supplied to the digital TV 100 from the DVDP 330 of the VCR/DVDP combo 300 is either a U.S type component video signal or European type RGB video signal. The video signal component of the A/V signals is an analog composite video signal. Hereinafter, component video signals and the RGB video signals will be identified as digital signals, while the composite video signals, such as composite video broadcast signal (CVBS), will be identified as analog signals.

The digital component video signals comprise a luminance signal Y and two color difference signals, P_{R-Y} and P_{B-Y}. The analog composite video signals are a combination of the luminance signal Y and a color signal C (=P_{R-Y}+P_{B-Y}). The audio signals supplied for the digital TV 100 are digital signals that can be converted into analog signals when output.

The analog A/V signals output from the VCR 310 of the VCR/DVDP combo 300 are converted to digital A/V signals, as either a component video signal or an RGB video signal. The digital video and the digital audio signals can then be supplied to the digital TV 100.

The digital TV 100 can output A/V signals of either an analog or a digital type as a viewable signal in accordance with manipulation of the remote controller 300a. For that purpose, the input terminal (not shown) of the digital TV has an analog input terminal and a digital input terminal.

As described above, analog A/V signals output from the VCR/DVDP combo 300 (e.g., the composite video signals that are analog audio signals) are provided to the analog input terminal of the digital TV 100. Digital A/V signals output from the VCR/DVDP combo 300 (e.g., the component video signals and any one of the RGB video signals that are digital audio signals) are provided to the digital input terminal of the digital TV 100. If the audio amplifier 200 has been connected to the VCR/DVDP combo 300, the digital audio signals are input to the audio amplifier 200.

For instance, if a DVDP reproducing mode is selected through manipulation of the remoter controller 300a, the analog A/V signals and the digital A/V signals are output to the digital TV 100. The digital TV 100 then selects a signal corresponding to a view mode selected from an analog view mode or a digital view mode. Thus, if the analog view mode is selected, the digital TV 100 selects an analog A/S signal input through the input terminal so as to be displayed.

If the DVDP reproducing mode and the digital view mode are selected through manipulation of the remote controller 300a, the DVDP 330 outputs the analog A/V signals and the digital A/V signals to the digital TV 100. The digital TV 100 then selects the digital A/V signals input through the digital input terminal (not shown) so as to be displayed.

FIG. 3 is a block diagram illustrating the VCR/DVDP combo 300 according to a preferred embodiment of the present invention.

The process of converting analog A/V signals (e.g., CVBS signals) output from a VCR 310 to digital A/V signals is described in greater detail below. Referring to FIGS. 2 and 3, the VCR/DVDP combo 300, according to an embodiment of the present invention, comprises a VCR 310, a first signal conversion unit 320, a DVDP 330, an analog selection unit 360, a first output terminal 370, and a second output terminal 380.

The VCR 310 includes a VCR deck 312, a VCR audio processing unit 314 and a VCR video processing unit 316. The VCR deck 312 includes a head having magnetic characteristics when electric current is applied. The VCR deck 312 either records the video and audio signals on a magnetic tape, or reproduces the video and audio signals recorded on the magnetic tape in accordance with the strength of the magnetic characteristics applied to the head.

The VCR audio processing unit 314 converts the audio signals to be recorded on the magnetic tape of the cassette to a recording format through the VCR deck 312, and converts the audio signals reproduced by the VCR deck 312 to a reproducing format that can be easily recognized by a peripheral device, such as the digital TV 100.

The VCR video processing unit 316 converts the video signals to be recorded on the magnetic tape of the cassette to a recording format through the VCR deck 312, and converts the video signals reproduced by the VCR deck 312 to a reproducing format that can be easily recognized by a peripheral device such as the digital TV 100.

The signals output after being converted to a reproducing format by the VCR audio processing unit 314 and the VCR video processing unit 316 are the first analog A/V signals. The first analog A/V signals are input in the first signal conversion unit 320 and the analog selection unit 360 that will be described in great detail below.

A VCR microcomputer can be provided to control the comprehensive operation of the VCR deck 312, the VCR audio processing unit 314 and the VCR video processing unit 316. However, the preferred embodiment of the present invention provides comprehensive control by means of the control unit 352 provided in the DVDP 330, and will be described in greater detail below.

The first signal conversion unit 320 includes a first audio conversion unit 322 and a first video conversion unit 324. The first audio conversion unit 322 is an analog/digital converter (ADC) for converting the first analog audio signal output from the VCR audio processing unit 314 to the first digital audio signal, and outputs the same.

The first video conversion unit 324 is the ADC for converting the first analog video signal output from the VCR video processing unit 316 to the first digital video signal, and outputs the same. The first digital video signal is output in a CCIR656 data format by a video decoder 324a, and has the characteristics of an interlaced scanning format. One example of a CCIR data format is Y:Cb:Cr=4:2:2.

The DVDP 330 comprises a DVD deck 332, a DVD servo 334, a DVD decoder 336, a digital audio selection unit 338, a digital video selection unit 340, a scanning format conversion unit 342, a second signal conversion unit 344, a third signal conversion unit 346, a command applying unit 348, a storing unit 350, and a control unit 352.

The DVD deck 332 generates the second digital A/V signals by loading the data recorded on a DVD to reproduce the DVD. The DVD servo 334 controls position and velocity of the DVD deck 332. The DVD decoder 336 decodes the generated second digital audio/video signals, and outputs the same. The second digital video signals generally have an interlaced scanning format.

The first digital audio signals output from the first audio ADC 322 and the second digital audio signals output from the DVD decoder 336 are input to the digital audio selection unit 338. The first digital video signals output from the video decoded 324a of the first video ADC 324 and the second digital video signals output from the DVD decoder 336 are input in the digital video selection unit 340.

The digital audio/video selection units 338 and 340 are realized with a switch such as a multiplexer. The digital audio/video selection units 338, 340 can select any one of the input signals and output the same in accordance with a selection made by a reproducing mode selection unit 348 and a control signal by the control unit 352. Selection of the input signals to the digital audio/video selection units 338, 340 will be described in greater detail below.

For example, if a VCR reproducing mode is selected by the reproducing mode selection unit 348a, the digital audio selection unit 338 selects the first digital audio signal output from the first audio ADC 322, and outputs the same to a second audio output terminal 382. The digital video selection unit 340 selects the first digital video signal with the CCIP656 data format output from the first video ADC 324, and outputs the same to the scanning format conversion unit 342.

The scanning format conversion unit 342 converts the scanning format of the video signals selected and output by the digital video selection unit 340. For example, the first and the second digital video signals input to the digital video selection unit 340 from the first video ADC 324 and the DVD decoder 336 are in interlaced scanning format. The scanning formation conversion unit 342 then converts the scanning format of the video signals selected by the digital video selection unit 340 to a progressive scanning format from the interlaced scanning format. The progressive scanning format provides the viewer with higher quality images than the interlaced scanning. Since the method of converting the scanning format is well known to those skilled in the art, description of it will be omitted here.

The image encoder 344a converts the video signal of the converted scanning format to a signal displayable on a digital display device. Signals displayable on the digital display device are known RGB video signals or unknown YCbCr video signals, etc.

The second signal conversion unit 344 is a digital/analog converter (DAC) for converting the video signals output from the video encoder 344a into analog signals. The video signals converted from the second DAC 344 are output to the second video output terminal 384.

The third DAC 346 converts the second digital A/V signals output from the DVD decoder 336 to the second analog A/V signals. The second analog audio signals converted from the third DAC 346 are output to the analog audio selection unit 362, and the second analog video signals are output to the analog video selection unit 364.

The command applying unit 348 is a user interface for generating commands to select or manipulate functions assisted by the VCR/DVDP combo 300 for the control unit 352. The command applying unit 348 comprises a plurality of numerical keys, direction keys, confirmation keys, among others, and resides, in the main body of the VCR/DVDP combo 300. It is also preferable to infrared receiver in the main body to receive the user's manipulating signals transmitted from an external input device, such as the remote controller 300a.

According to the preferred embodiment of the present invention, the command applying unit 348 and the remote controller 300a have a reproducing mode selection unit 348a for applying a selection signal to the control unit 352 for either the VCR reproducing mode or the DVDP reproducing mode.

A control program is stored in the storing unit 350 to control and manage comprehensive operation of the VCR/DVDP combo 300. The control unit 352 controls comprehensive operation of the VCR/DVDP combo 300 in accordance with the reproducing mode selection signal applied from the reproducing mode selection unit 348a upon input or selection of a key by the user as well as with the control program stored in the storing unit 350.

Operation of the control unit 352 according to the present invention will now be described in further detail. The control unit 352 controls the first ADC 320, which converts the first analog AN signal output from the VCR 310 to the first digital A/V signals. The control unit 352 also controls conversion of the video signal of a converted scanning format to a displayable signal by controlling the second DAC 344.

The control unit 352 also controls reproducing of the VCR 310 and the DVDP 330 in accordance with a reproducing mode selection signal from the reproducing mode selection unit 348a. The control unit 352 further controls the signal selection of the analog selection unit 360 and the digital audio/video selection units 338, 340.

The analog selection unit 360 has an analog audio selection unit 362 and an analog video selection unit 364. The first analog audio signal, which is output from the VCR audio processing unit 314, and/or the second analog audio signal, which is output from the third DAC 346, are input to the analog audio selection unit 362. The first analog video signal, which is output from the VCR video processing unit 316, and/or the second analog video signal, which is output from the third DAC 346 is input to the analog video selection unit 364.

The analog audio/video selection units 362, 364 are realized by switches, such as a multiplexer, so as to select any one of the input signals through selection by the reproducing mode selection unit 348a, and control by the control unit 352.

For example, if a VCR reproducing mode is selected by the reproducing mode selection unit 348a, the analog audio selection unit 362 selects the first analog audio signal input from the VCR audio processing unit 314, and outputs the same to a first audio output terminal 372. Similarly, the analog video selection unit 364 selects the first analog video signal output from the VCR video processing unit 316, and outputs the same to a first video output terminal 374.

The first output terminal 370 is a composite output terminal comprising the first audio output terminal 372 and the first video output terminal 374. The first audio output terminal 372 supplies the analog audio signals output from the analog audio selection unit 362 to speakers provided in the digital TV 100. The first video output terminal 374 supplies the analog video signals output from the analog video selection unit 364 to the digital TV 100.

The second output terminal 380 is a component output terminal comprising a second audio output terminal 382 and a second video output terminal 384. The second audio output terminal 382 supplies the digital audio signals output from the digital audio selection unit 338 to the speakers provided in the digital TV 100, or to the audio amplifier 200. As described above, the second audio output terminal 382 is connected to an input terminal of the audio amplifier 200. Thus, the digital audio signals output from the digital audio selection unit 338 are supplied to the audio amplifier 200. The second video output terminal 384 supplies the RGB video signals or the YCbCr video signals output from the second DAC 344 to the digital TV 100.

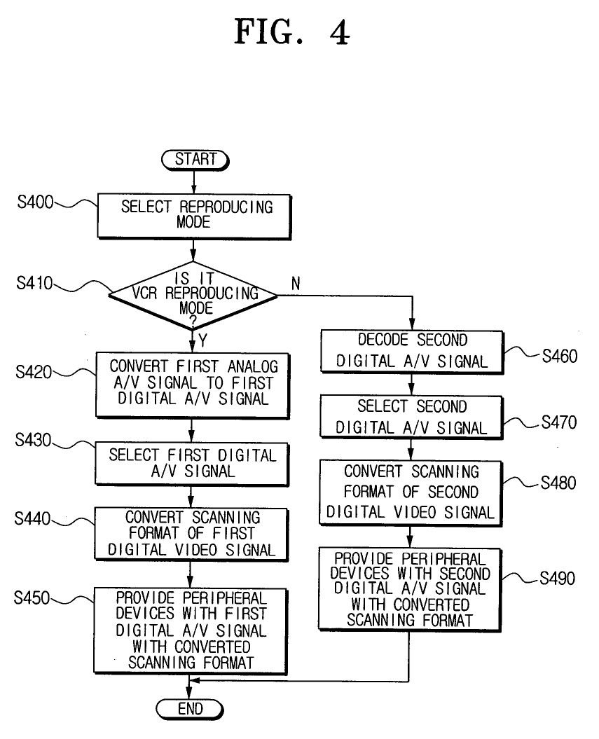

FIG. 4 is a flowchart illustrating a method of controlling output signals by the VCR/DVDP combo in FIG. 3.

Referring to FIGS. 2 to 4, once a reproducing mode is selected by the reproducing mode selection unit 348a or the command applying unit 348 (step S400), the control unit 352 determines whether or not a VCR reproducing mode has been selected (decision step S410). If a VCR reproducing mode was selected (“Yes” path from decision step S410), the first signal conversion unit 320 converts the first analog A/V signals generated from the VCR 310 according to controls generated by the control unit 352 into the first digital A/V signals (S420).

After step 420 is performed, the digital audio selection unit 338 selects either the first digital audio signal or the second digital audio signal output from the DVD decoder 336 as the selected first digital audio signal. The digital video selection unit 340 also selects either the first digital video signal or the second digital video signal output from the DVD decoder 336 (S430) as the selected first digital video signal.

The scanning format conversion unit 342 converts the scanning format of the selected first digital video signal to a progressive scanning format according to controls generated by the control unit 352. The second DAC 344 converts the first digital video signal of a converted scanning format to the RGB video signals or YCbCr video signals displayable on the digital TV 100 (S440).

As a result, the first selected digital A/V signals of a converted scanning format are supplied to a peripheral device, such as the digital TV 100, through the second output terminal 380 (S450). Here, it is out of question that the first analog A/V signals are supplied to a peripheral device such as the digital TV 100 through the first output terminal 370 when steps S420 to S450 are performed.

If however, a DVDP reproducing mode is determined to have been selected in step S410 (“No” path from decision step S410), the DVD decoder 336 decodes the second digital A/V signals according to controls generated by the control unit 352 (S460).

After step S460 is performed, the digital audio selection unit 338 selects either the first digital audio signal or the second digital audio signal as the selected second digital audio signal. Similarly, the digital video selection unit 340 also selects either the first digital video signal or the second video signal as the selected second digital video signal(S470).

The scanning format conversion unit 342 converts the scanning format of the selected second digital video signal to a progressive scanning format through controls generated by the control unit 352. The second DAC 344 converts the second digital video signal of a converted scanning format to the RGB video signals or YCbCr video signals displayable on the digital TV 100 (S480).

The second digital A/V signal of a converted scanning format is supplied to a peripheral device, such as the digital TV 100, through the second output terminal 380 (S490). As a result, the second analog A/V signals converted through the third DAC 346 cannot be supplied to a peripheral device such as the digital TV 100 when steps S460 to S490 are performed.

As described above, when the VCR/DVDP combo 300 in accordance with a preferred embodiment of the present invention is connected to either the digital TV 100 or an analog TV, the A/V signals supplied from the VCR 310 are the first analog A/V signals and the first digital A/V signals, while the A/V signals supplied from the DVDP 330 are the second analog A/V signals and the second digital A/V signals. Therefore analog or digital A/V signals are selectively output in accordance with the viewing mode set in the digital TV 100 or the analog TV when connected as a peripheral device.

The VCR/DVDP combo 300 as described above also comprises a channel selection unit (not shown) and an external input terminal (not shown).

The channel selection unit is a tuner receiving public wave broadcast signals. The channel selection unit, which is connected to an antenna for selecting a predetermined channel from a plurality of received channels, tunes the broadcast signals received through the antenna, and supplies the same to the first ADC 320. The broadcast signals, converted and output as the digital A/V signals from the first ADC 320, are respectively input into the digital audio selection unit 338 and the digital video selection unit 340.

The VCR/DVDP combo 300 can support various available AN signal sources, such as digital satellite broadcasting, cable broadcasting, network broadcasting through Internet, and so on. Therefore, the channel selection unit can select not only the broadcasting signals but also the channels with respect to other A/V signals.

The external input terminal supplies signals input from external appliances, such as a camcorder to the analog selection unit 360. If analog AN signals are input from an external appliance connected to the external input terminal, the VCR 310 records the input analog A/V signals on a magnetic tape. Additionally, the VCR/DVDP combo 300 outputs the analog A/V signals input from the external appliance to the first output terminal 370. The VCR/DVDP combo 300 then converts the analog A/V signals input from the external appliance into digital A/V signals, which are output to the second output terminal 380 and displayed on the digital TV.

In the combination system capable of controlling output signals and a method of controlling the same, according to an embodiment of the present invention, the analog A/V signals output from a VCR of the combination system are converted to digital A/V signals and supplied to a peripheral device, such as a digital TV. As a result, the embodiments of the present invention enables a user to view high quality screen images and listen to high quality sound. In particular, the embodiments of the present invention provides the user with high quality screen images by converting the scanning format of the video signals to a progressive scanning format prior to supplying the video signals to the digital TV.

While the invention has been shown and described with reference to a certain preferred embodiment thereof, it will be understood by those skilled in the art that various changes in form and details may be made therein without departing from the spirit and scope of the invention as defined by the appended claims.

I claim:

1. A combination video reproduction and playback system, comprising:
a first device for generating first analog audio/video signals by reproducing data recorded on a first recording medium,
a first signal converting unit for converting the first analog audio/video signals into first digital audio/video signals and outputting the first digital audio/video signals, and
a second device for generating second digital audio/video signals by reproducing data recorded on a second recording medium, and outputting either the first or second digital audio/video signals as selected digital audio/video signals.

2. The combination video reproduction and playback system according to claim 1, wherein the second device comprises a converter for converting a scanning format of the selected video signal.

3. The combination video reproduction and playback system according to claim 2, further comprising:
an image encoding device, for encoding the scanning format converted selected video signal to change the selected video signal from a digital video signal to a displayable signal format.

4. The combination video reproduction and playback system according to claim 3, wherein the displayable signal format comprises either a RGB video signal or a YCbCr video signal.

5. The combination video reproduction and playback system according to claim 1, wherein the first device comprises:
a VCR video processing unit; and
a VCR audio processing unit.

6. The combination video reproduction and playback system according to claim 1, wherein the first signal converting unit comprises:
a first video analog-to-digital converter; and
a first audio analog-to-digital converter.

7. The combination video reproduction and playback system according to claim 1, wherein the second device comprises:
a digital audio selection unit for receiving the first and second digital audio signals and selecting either the first or second digital audio signals; and
a digital video selection unit for receiving the first and second digital video signals and selecting either the first or second digital video signals.

8. The combination video reproduction and playback system according to claim 7, further comprising:
a scanning format unit for receiving the selected digital video signal and formatting the digital video signal.

9. The combination video reproduction and playback system according to claim 8, wherein the scanning format unit formats the digital video signal from an interlaced scanning format to a progressive scanning format.

10. A method for controlling a combination video reproduction and playback system, comprising:
selecting a reproducing mode by a user;
determining whether the selected reproducing mode is a VCR reproducing mode;
converting a first analog audio/video signal into a first digital audio/video signal if the selected reproducing mode is a VCR reproducing mode; and
providing a peripheral device with a converted scanning format first digital audio/video signal.

11. The method for controlling the combination video reproduction and playback system according to claim 10, wherein the providing step comprises:
selecting the first digital audio/video signal instead of a second digital audio/video signal;
converting a scanning format of the first digital audio/video signal from a first scanning format to a second scanning format; and
outputting the second scanning format first digital signal through a second video output terminal to a peripheral device.

12. The method for controlling the combination video reproduction and playback system according to claim 11, wherein the first scanning format is an interlaced scanning format, and the second scanning format is a progressive scanning format.

13. The method for controlling the combination video reproduction and playback system according to claim 11, wherein the peripheral device includes a digital television.

14. The method for controlling the combination video reproduction and playback system according to claim 10, further comprising:
decoding a second digital audio/video signal if the selected reproducing mode is not a VCR reproducing mode;
selecting a second digital audio/video signal instead of a first digital audio/video signal;
converting a scanning format of the second digital audio/video signal from a first scanning format to a second scanning format; and
outputting the second scanning format second digital signal through a second video output terminal to a peripheral device.

15. The method for controlling the combination video reproduction and playback system according to claim 14, wherein the first scanning format is an interlaced scanning format, and the second scanning format is a progressive scanning format.

16. The method for controlling the combination video reproduction and playback system according to claim 14, wherein the peripheral device includes a digital television.

17. A method for operating a combination video reproduction and playback system, comprising:
generating a first analog audio/video signal by reproducing data recorded on a first recording medium, converting the first analog audio/video signals into first digital audio/video signals and outputting the first digital audio/video signals, and generating second digital audio/video signals by reproducing data recorded on a second recording medium; and
outputting either the first or second digital audio/video signals as selected digital audio/video signals.

18. The method for operating a combination video reproduction and playback system according to claim 1, further comprising converting a scanning format of the selected video signal.

19. The method for operating a combination video reproduction and playback system according to claim 18, further comprising:
encoding the converted scanning format selected video signal to change the selected video signal from a digital video signal to a displayable signal format.

20. The method for operating a combination video reproduction and playback system according to claim 19, wherein the displayable signal format comprises either a RGB video signal or a YCbCr video signal.

21. The method for operating a combination video reproduction and playback system according to claim 17, wherein the step of generating a first analog audio/video signal comprises:
operating a VCR video processing unit and a VCR audio processing unit to produce the analog audio/video signals.

22. The method for operating a combination video reproduction and playback system according to claim 17, wherein the step of converting the first analog audio/video signals comprises:
operating a first video analog-to-digital converter and a first audio analog-to-digital converter to produce the first digital audio/video signals.

23. The method for operating a combination video reproduction and playback system according to claim 17, further comprising:
receiving the first and second digital audio signals and selecting either the first or second digital audio signals; and
receiving the first and second digital video signals and selecting either the first or second digital video signals.

24. The method for operating a combination video reproduction and playback system according to claim 23, further comprising:
receiving the selected digital video signal and formatting the digital video signal.

25. The method for operating a combination video reproduction and playback system according to claim 24, wherein the step of formatting the digital video signal comprises:
formatting the digital video signal from an interlaced scanning format to a progressive scanning format.
